(19) United States
(12) Patent Application Publication
(10) Pub. No.: US 2007/0180024 A1
(43) Pub. Date: Aug. 2, 2007

(54) Methods and systems for control of content reception

(76) Inventors: Gregory A. Piccionelli, Westlake Village, CA (US); Michael M. Gerardi, Menifee, CA (US)

Correspondence Address: Michael M. Gerardi, 28876 Woodcrest Lake Drive, Menifee, CA, 92584, US

(21) Appl. No.: 11/699,836

(22) Filed: Jan. 30, 2007

Related U.S. Application Data
(60) Provisional application No. 60/764,300, filed on Jan. 31, 2006.

(51) Int. Cl. G06F 15/16

(52) U.S. Cl. 709/203

(57) ABSTRACT

A method of preventing the reception of content includes the steps of receiving a request for provision of content from a content reception system, the content reception system comprising a signal detector, and preventing the reception of content by the content reception system when the signal detector detects a signal indicating that the content is to be received by a receiver who does not satisfy a reception criterion.

This application is based on U.S. Provisional Patent Application Ser. No. 60/764,300, filed Jan. 31, 2006, the entire disclosure of which is incorporated herein by reference.

### FIELD OF THE INVENTION

Content The present invention relates to methods and systems for regulating the reception of content, and in more particular aspects for preventing the reception of content by persons unauthorized to receive the content.

### BACKGROUND OF THE INVENTION

Content which is intended for distribution to or viewing by limited audiences is widely produced. Such content can include adult entertainment, advertisements for tobacco sales, information pertaining to gambling, and the like, which is intended to be viewed by an age-restricted audience (typically those age 18 or over). Other content can include information intended to be viewed by audiences limited to members of particular institutions or organizations, such as schools, private clubs, and the like.

Content of all kinds is readily available today from a wide variety of media. Many sites on networks, particularly wide-area networks such as the Internet, include subject matter which is intended for viewing by users over a certain age, for example age 18. Data-storage media such as CD's, DVD's, zip drives, and the like, can provide content directly to a receiving individual (“receiver”) using a home play-back device, rather than via a network.

Regulating the provision of content to potential receivers, some of whom may not meet pertinent restrictions such as age or membership, has proven problematic. In particular cases, it has proven difficult to verify that a user claiming to be an adult user is in fact an adult user. Use of false identification, or submission of false declarations of adult status, can thwart many age-verification procedures. Similar difficulties can occur when other content-reception requirements must be satisfied.

A need exists for methods and systems that can regulate the reception of content by a receiver. More particularly, a need exists for methods and systems that prevent unauthorized receivers from receiving content, and alternatively that enable authorized receivers to receive content.

### SUMMARY OF THE PREFERRED EMBODIMENTS

In accordance with one aspect of the present invention, there is provided a method of preventing the reception of content. The method includes the steps of: receiving a request for provision of content from a content reception system, the content reception system including a signal detector, and preventing the reception of content by the content reception system when the signal detector detects a signal indicating that the content is to be received by a receiver who does not satisfy a reception criterion.

In some circumstances, it is desirable to limit the operation of methods of the invention to certain categories of content, for example adult content, content containing references to tobacco or alcohol use, violent content, etc. Thus, according to particular aspects of the invention, the content includes a label which activates the signal detector when the request for provision of the content is received.

Embodiments of the inventive method are advantageously implemented when the receiver of the content (i.e., the person who requests provision of the content) is associated in some manner with a device or element which initiates the method. According to specific embodiments of the invention, therefore, the receiver possesses a signal transmitter, such as a short-range radio-frequence transmitter, IR transmitter or the like, which transmits a signal detectable by the signal detector. The signal transmitter is incorporated into an object which is in the possession of the receiver, such as a hand-held device, in some particular embodiments, is worn by the receiver, such as a ring or an item of clothing (“smart clothing”), in other particular embodiments, or is implanted into the receiver, in still other particular embodiments.

It may be desirable to prevent adjacent receivers from interfering with each others' requests for provision of content. Thus, according to more particular embodiments, the signal transmitter has a range that is shorter than a distance from the transmitter to an adjacent content reception system.

Reception criteria can be freely selected. In certain specific embodiments, the reception criterion is an age limitation, for example, age eighteen. In other specific embodiments, the reception criterion is membership in a set of authorized receivers, such as the employees of a company, members of a club or other social organization, students at a school, and the like.

Content reception systems useful according to various specific embodiments of the inventive method include, without limitation, computers, hand-held telecommunication devices, DVD players, videotape players, televisions, radios, cable boxes, and satellite boxes. The signal detector is incorporated into the selected device in certain particular embodiments. In other particular embodiments, the signal detector is in communication with the selected device, for example via an electrical cable or a short-range transmitter.

Particular embodiments of the inventive method make use of computers as part of the content reception system. According to such embodiments, a receiver used the computer to make a request to access a site on a network and view content provided by the site, or alternatively, to access a data-storage medium such as a CD-ROM.

In some circumstances it may be desirable to deactivate the signal detector or otherwise disable the system. Thus, according to certain specific embodiments, the signal detector is deactivated after the content reception system is activated for a predetermined time. According to other specific embodiments, the signal detector includes a deactivation element enabling deactivation of the signal detector.

According to another aspect of the invention, there is provided a system for preventing the reception of content. The system includes a content reception system, the content reception system including a signal detector; a signal transmitter which transmits a signal detectable by the signal detector; and a content reception disabling element which prevents the reception of content by the content reception system when the signal detector detects a signal from the signal transmitter indicating that the content is to be received by a receiver who does not satisfy a reception criterion.

The foregoing methods and systems control content reception by preventing reception of the content by those not authorized to receive it. Conversely, content reception can be controlled by enabling reception of the content by those who are authorized to receive it. Thus, in accordance with another aspect of the present invention, there is provided a method of receiving content. The method includes the steps of activating a content reception system, the content reception system including a signal detector, and receiving content using the content reception system when the signal detector detects a signal confirming that the content is to be received by a receiver who satisfies a reception criterion.

According to a further aspect of the present invention, there is provided a system for receiving content. The system includes a content reception system, the content reception system comprising a signal detector, a signal transmitter which transmits a signal detectable by the signal detector, and a content reception enabling element which enables the reception of content by the content reception system when the signal detector detects a signal from the signal transmitter indicating that the content is to be received by a receiver who satisfies a reception criterion.

Content reception can be disabled or enabled at the same physical location from which a request for content reception is made. Alternatively, content reception can be requested at a first physical location, and the content can be received at a second physical location. Thus, in accordance with yet another aspect of the present invention, there is provided a method of receiving content that includes the steps of: activating a content reception system at a first physical location, the content reception system comprising a signal detector; obtaining an access code authorizing reception of content when the signal detector detects a signal confirming that the content is to be received by a receiver who satisfies a reception criterion; and using the access code to receive the content at a second physical location.

In specific embodiments, the step of obtaining the access code includes accessing a site on a network and requesting to view content provided by the site, and the access code authorizes reception of content provided by the site.

Systems for receiving content implementing the foregoing methods, according to still another aspect of the present invention, include a first content reception system, the content reception system comprising a signal detector; a second content reception system; a signal transmitter which transmits a signal detectable by the signal detector; and a content reception enabling element which generates an access code enabling the reception of content by the second content reception system when the signal detector detects a signal from the signal transmitter indicating that the content is to be received by a receiver who satisfies a reception criterion.

More specific embodiments of the foregoing system further include a recorder, such as a DVD burner, in communication with the second content reception system.

Other features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which

FIG. 1 is an illustration of a system for implementing a method according to an embodiment of the invention, in which a receiver, having in his possession a signal transmitter, attempts to access a site on a network and receive content from the site by means of a computer equipped with a signal detector,

FIG. 2 is an enlargement of a portion of the system of FIG. 1, showing the relationships of the computer, the signal detector, the signal receiver and the content receiver,

FIG. 3 is a flowchart illustrating a method according to another embodiment of the invention which enables reception of content by an authorized receiver,

FIG. 4 is a flowchart illustrating a method according to an embodiment of the invention which prevents reception of content by an unauthorized receiver, and

FIG. 5 is a flowchart illustrating an embodiment of an alternative method according to the invention for requesting content reception at a first physical location and receiving the content at a second physical location.

Like numerals refer to like parts throughout the several views of the drawings.

### DETAILED DESCRIPTION OF THE PREFERRED EMBODIMENTS

Turning now to the drawings, in FIG. 1 system 10 includes computer 12 which is in communication with a web site maintained on a host computer 14. Computer 12 includes signal detector 16, which can be, in particular embodiments, a short-range radio device, an infrared device or any other desired signal detecting device. A human receiver desiring to receive content from the website attempts to access the website using computer 12.

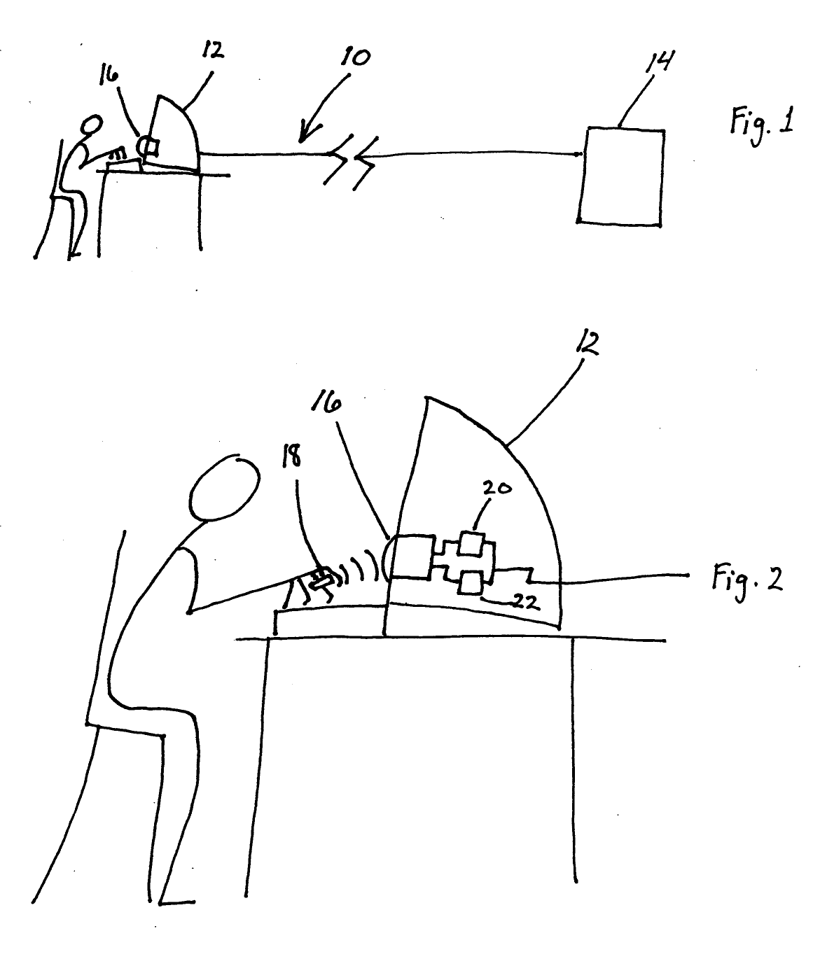

In FIG. 2, the human receiver has in his possession a signal transmitter 18, as illustrated a device incorporated into a ring which is worn by the receiver. The signal transmitter 18 transmits a signal which indicates that the receiver does not satisfy a reception criterion, for example, that the receiver is under the age of 18. The signal detector 16 is capable of detecting the signal from signal transmitter 18.

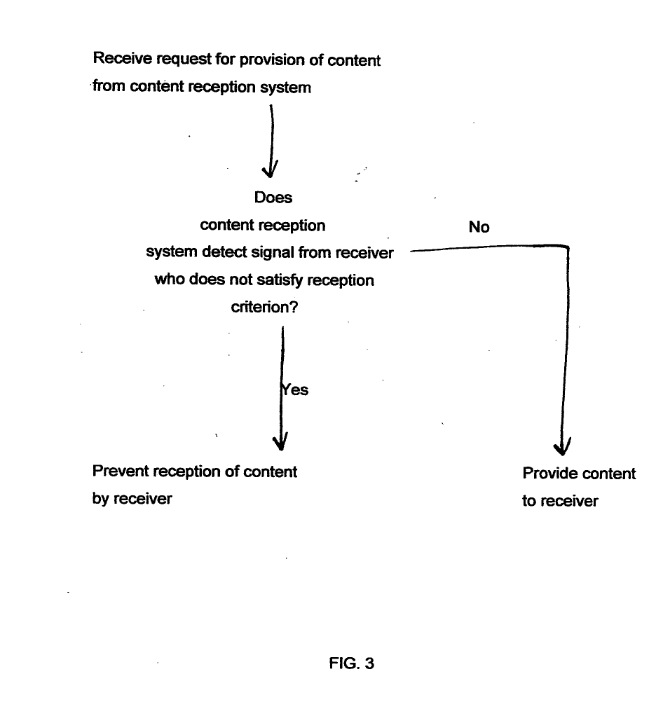

A general method for preventing reception of content is illustrated in FIG. 3. The human receiver submits a request for provision of content, for example by using the computer 12, and the request is received by the host computer 14. The content reception system, including computer 12 equipped with signal detector 16, determines whether signal transmitter 18 transmits a signal as described, indicating that the reception criterion is not satisfied. If the signal is detected, system 10 prevents the human receiver from receiving the requested content. Otherwise, the content is provided to the receiver.

The signal transmitted by signal transmitter 18 and the nature of the requested content can, in particular embodiments, determine whether or not the system 10 operates to prevent reception of the content by the receiver. This can be accomplished, for example, by providing the content with a label. In response to the request for provision of content, any label with which the content has been provided is transmitted to computer 12. Receipt of the label causes computer 12 to activate signal detector 16. Once signal detector 16 has been activated, transmission of a signal corresponding to the label must be detected in order for the receiver to receive the content. For example, when the content is labeled as being age-restricted, signal detector 16 must detect transmission of a signal indicating that the receiver meets the age restriction. Failure to detect the appropriate signal results in preventing the receiver from receiving the requested content.

Signal transmitter 18 can be incorporated into various objects in the possession of the receiver, including without limitation jewelry, such as rings, bracelets, brooches, pendants, medallions and the like; hand-held objects such as cellular telephones, PDA's and remote-control devices; and worn items, such as eyeglasses, shirt or jacket buttons, and “smart clothing” into which electronic devices are incorporated. Alternatively, the signal transmitter can be implanted into the receiver.

Two or more signal transmitters 18 can be used if desired. In certain embodiments, multiple signal transmitters are used, each transmitter transmitting a different signal corresponding to a different reception criterion.

Signal transmitter 18 has a range that is shorter than a distance from the transmitter to an adjacent content reception system in particular embodiments of the inventive method. This reduces or eliminates interference from nearby signal transmitters that may inadvertently prevent reception of content by an adjacent receiver who satisfies the reception criterion appropriate for the requested content.

Reception criteria can be freely determined by the content producers and/or providers. Non-limiting examples of reception criteria include age (e.g., eighteen years or older); membership in a set of authorized receivers, for example, status as a student in a specified educational institution or status as a member in an organization (e.g., social, athletic, religious, scientific) for which the content was produced; and the like. Signal transmitter 18 transmits a signal indicating whether or not the receiver meets the selected reception criterion.

Content reception systems including computers in communication with a network have been employed in the embodiments described above. Other devices for the provision of content can also be utilized. Hand-held telecommunication devices, such as cellular telephones, DVD players, videotape players, televisions, radios, cable boxes, satellite boxes, etc., can all be utilized in further embodiments of methods according to the invention. All such devices can incorporate a signal detector as discussed above; alternatively, the devices can be in communication with the signal detector via an electrical cable or other connecting element.

Requests for provision of content can be received in numerous ways. When the content reception system includes a computer, the request for provision of content can be received by a site on a network to which the computer is connected. Attentively, the computer can include a playback device for use with a data-storage medium such as a DVD, a CD-ROM, a floppy disk, a hard drive, or the like. In these embodiments, a command to access the data-storage medium constitutes the request for provision of content.

In certain circumstances it may be desirable to deactivate the signal detector. For example, a receiver who has initially provided (via signal transmitter 18) the appropriate reception criterion may receive and view content for a predetermined length of time, after which further requirements for provision of the reception criterion may be dispensed with. Thus, in such embodiments the signal detector is deactivated after the predetermined length of time. Alternatively, the content reception system can include a deactivation element, such as a switch, a key or the like, which can be incorporated into the signal detector or in communication with the signal detector.

Systems useful in practicing methods of the invention as described above include a content reception system, including a signal detector; a signal transmitter which transmits a signal detectable by the signal detector; and a content reception disabling element (such as an electronic circuit; see FIG. 2, element 20). The last element prevents reception of content by a receiver when the signal transmitter transmits a signal indicating that the receiver does not satisfy a reception criterion associated with the content.

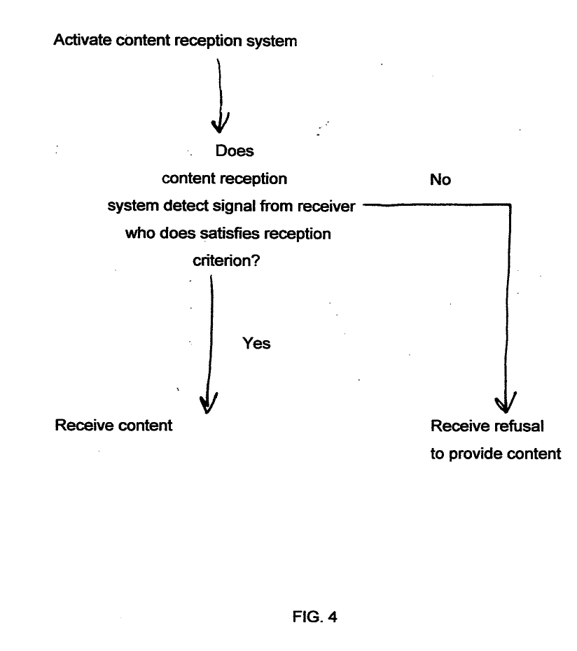

The foregoing embodiments of the invention are beneficially employed in preventing the reception of content by unauthorized receivers. Conversely, reception of content by authorized receivers is enabled according to further embodiments of the invention. In such embodiments, a content reception system as described above is activated, typically by a human who desires to receive content. The signal detector of the content reception system detects a signal identifying the receiver as a person who satisfies a reception criterion associated with the desired content. The content is then provided to the receiver (see FIG. 4).

Systems for implementing embodiments of the inventive method of content reception include a content reception system as described above, a signal transmitter, again as described above, and a content reception enabling element (such as an electronic circuit; see FIG. 2, element 22) that enables reception of the content when a signal indicating that the receiver meets a reception criterion associated with the content is detected by the signal detector.

Additional methods and systems within the scope of the invention make use of both content reception disabling elements and content reception enabling elements. Such methods and systems afford additional flexibility in controlling the reception of content by different potential receivers.

The foregoing embodiments are directed to the control of content reception at a location from which a request for the content originates. Alternative embodiments of content reception methods according to the invention employ first and second physical locations. In such embodiments, a request for receiving content originates at a first physical location at which a content reception system including a signal detector, as described herein, is located. A request for reception of content originates at this location, and, upon detection by the signal detector of a signal confirming that the content is to be received by a receiver who satisfies a reception criterion (e.g., a minimum age as discussed above), an access code is provided. The access code enables a receiver to receive the content at a second physical location.

Embodiments of the foregoing alternative method are beneficially practiced, for example, at a first physical location such as a store or other place of business. In such embodiments, a store proprietor maintains a content reception system as described herein, more specifically a content reception system including a computer in communication with a network. Store customers are invited to view one or more sites on the network from which content may be requested, subject to their meeting a reception criterion. When it is determined that the customer meets the reception criterion, an access code is provided to the customer (via the content reception system at the first physical location or via alternative communications pathways such as by cellular telephone or other communication device). The customer then uses the access code to receive the requested content at a second content reception system at a second physical location. In certain embodiments, the second content reception system is a personal computer and the second physical location is a fixed location, e.g., within a structure, such as the customers home. In other embodiments, the second content reception system is a portable laptop computer, cellular telephone or other communication device carried by the customer, and the second physical location is not a fixed location.

The access code can be obtained in various ways. In certain particular embodiments, the possessor of the content reception system at the first physical location, such as a store proprietor, initially satisfies the reception criterion, and is subsequently approved for future reception of content, whether at the first physical location or at a second physical location by use of an access code. The possessor then controls access to the content reception system by customers. Typically, the proprietor or other system possessor will require that the customer prove that he satisfies the appropriate reception criterion, such as by showing proof of legal age.

In other particular embodiments, the possessor of the content reception system separately satisfies the reception criterion each time content is requested (by the possessor, or by another requester such as a customer). In still other particular embodiments, the customer provides proof of satisfaction of the reception criterion, and the possessor of the content reception system then permits the customer to operate the content reception system in a manner as described previously.

In all embodiments, once the customer has satisfied the reception criterion, an access code is obtained. The access code enables the customer to receive the content at a second physical location, for example, a personal computer in the possession of the customer. The access code can also, in certain particular embodiments, enable the customer to receive and view the content on the content reception system present at the first physical location. In such embodiments, the proprietor first obtains the access code (after the customer satisfies the reception criterion), and uses it to receive the content on the proprietor's content reception system. The proprietor then permits or enables the customer to browse the content. If the customer is satisfied with the content, the proprietor then provides the customer with the access code for his subsequent use at a second physical location. Alternatively, the customer browses a hard copy or other sample of at least a portion of the available content, and if he so desires, is then provided with an appropriate access code.

In more particular embodiments of the foregoing method, the customer is provided with a recording device, such as a DVD burner, for use with the second content reception system. In alternative embodiments, the second content reception system already includes such a recording device, obviating the need for a separate device.

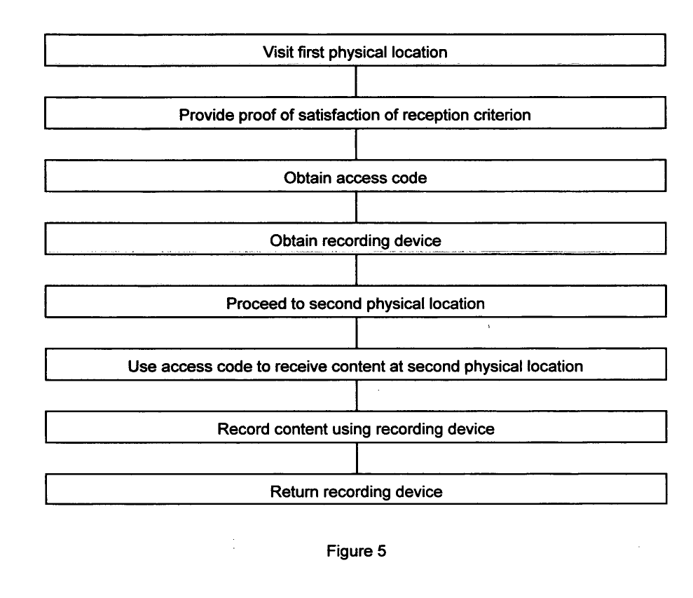

Embodiments of the foregoing method facilitate a business model which reduces or eliminates the need for storage of content in tangible form, such as DVD's, video tapes, printed materials or the like, at a business location. Such a method is illustrated in FIG. 5. In the first step of the method, a customer visits a store or other commercial establishment (the first physical location) offering access to desired content via a computer or other content reception system. The customer next provides proof of satisfaction of an appropriate reception criterion to the proprietor. An access code is then obtained, and is provided to the customer, typically after the customer has browsed one or more sites offering content of interest, selected the desired content, and paid an appropriate premium. The customer then leaves the store and proceeds to a second physical location, such as the customer's home. The customer then utilizes a second content reception system at the second physical location, and, utilizing the access code, receives the selected content at the second physical location. In the particular embodiment illustrated, the proprietor provides a recording device, such as a DVD burner, and/or a recording medium, such as a DVD, to the customer, enabling the customer to record the requested content at the second physical location. When a recording device is so provided (e.g., after payment of a rental premium which may be part of the premium paid to receive the access code), the customer returns the device to the proprietor after use. The proprietor has thus enabled a recording of the desired content to come into the possession of the customer, without the need for maintaining a stock of recordings on-site.

What is claimed is:

1. A method of preventing the reception of content, the method comprising the steps of:
a) receiving a request for provision of content from a content reception system, the content reception system comprising a signal detector, and
b) preventing the reception of content by the content reception system when the signal detector detects a signal indicating that the content is to be received by a receiver who does not satisfy a reception criterion.

2. The method of claim 1 wherein the content comprises a label which activates the signal detector.

3. The method of claim 1 wherein the receiver possesses a signal transmitter which transmits a signal detectable by the signal detector.

4. The method of claim 3 wherein the signal transmitter is incorporated into an object in the possession of the receiver.

5. The method of claim 4 wherein the object is worn by the receiver.

6. The method of claim 4 wherein the object is implanted into the receiver.

7. The method of claim 3 wherein the signal transmitter has a range that is shorter than a distance from the signal transmitter to an adjacent content reception system.

8. The method of claim 1 wherein the content reception system comprises a device selected from the group consisting of a computer, a hand-held telecommunication device, a DVD player, a videotape player, a television, a radio, a cable box, and a satellite box.

9. The method of claim 8 wherein the signal detector is incorporated into the selected device.

10. The method of claim 8 wherein the signal detector is in communication with the selected device.

11. The method of claim 8 wherein the device is a computer.

12. The method of claim 9 wherein step a) comprises receiving a request to access a site on a network and view content provided by the site.

13. The method of claim 9 wherein step a) comprises receiving a command to access a data-storage medium.

14. The method of claim 1 wherein the signal detector is deactivated after the content reception system is activated for a predetermined time.

15. The method of claim 1 wherein the content reception system includes a deactivation element enabling deactivation of the signal detector.

16. A method of receiving content, the method comprising the steps of:
a) activating a content reception system, the content reception system comprising a signal detector, and
b) receiving content using the content reception system when the signal detector detects a signal confirming that the content is to be received by a receiver who satisfies a reception criterion.

17. The method of claim 16 wherein step a) comprises accessing a site on a network and requesting to view content provided by the site.

18. The method of claim 16 wherein step a) comprises accessing a data-storage medium.

19. The method of claim 16 wherein the signal detector includes a deactivation element enabling deactivation of the signal detector.

20. A method of receiving content, the method comprising the steps of:
a) activating a content reception system at a first physical location, the content reception system comprising a signal detector,
b) obtaining an access code authorizing reception of content when the signal detector detects a signal confirming that the content is to be received by a receiver who satisfies a reception criterion, and
c) using the access code to receive the content at a second physical location.
